(19) United States
(12) Patent Application Publication
(10) Pub. No.: US 2019/0100156 A1
(43) Pub. Date: Apr. 4, 2019

(54) SYSTEM AND METHOD FOR CONTROLLING A DISPLAY

(71) Applicant: GM GLOBAL TECHNOLOGY OPERATIONS LLC, Detroit, MI (US)

(72) Inventors: Caroline Chung, Royal Oak, MI (US); Jonathan T. Caulton, Royal Oak, MI (US)

(21) Appl. No.: 15/720,483

(22) Filed: Sep. 29, 2017

(51) Int. Cl. B60R 11/04; G06K 9/00; B60Q 1/00

(52) U.S. Cl. CPC B60R 11/04; B60R 2001/1253; B60Q 1/0023; G06K 9/00805

(57) ABSTRACT

A display system includes a camera configured to capture raw images of a region proximate a vehicle. A housing is coupled to an interior portion of the vehicle and is movable between distinct first and second positions. A position sensor is coupled to the housing and configured to produce a first signal in response to the housing being in the first position and a second signal in response to the housing being in the second position. A controller is in communication with the camera and the sensor. The controller is configured to process the raw images, output display images with a first field of view in response to the first signal, and output display images with a second field of view in response to the second signal. A display screen is disposed in the housing, and is in communication with the controller and configured to display the display images.

### TECHNICAL FIELD

The present disclosure relates to display systems, and more particularly to display systems implemented in automotive vehicles.

### INTRODUCTION

Automotive vehicles may be provided with vision systems, such as backup camera systems which capture images of a region behind the vehicle for display when the vehicle is in a reverse gear. Conventionally, images from such vision systems are displayed on an in-vehicle display disposed on a dashboard or center console. More recently, display systems have been integrated into in-vehicle rearview mirror assemblies. Such display systems, which may be referred to as dynamic rearview mirrors, display images of a region behind the vehicle as a supplement to, or replacement for, conventional rearview mirrors.

### SUMMARY

A display system according to the present disclosure includes a camera configured to capture raw images of a region proximate a vehicle. The system additionally includes a housing which is movably coupled to an interior portion of the vehicle. The housing is movable between distinct first and second positions. The system also includes a position sensor coupled to the housing. The position sensor is configured to produce a first signal in response to the housing being in the first position and a second signal in response to the housing being in the second position. The system further includes a controller in communication with the camera and the sensor. The controller is configured to process the raw images, output display images with a first field of view in response to the first signal, and output display images with a second field of view in response to the second signal. The system further includes a display screen disposed in the housing. The display screen is in communication with the controller and configured to display the display images.

In exemplary embodiments, the position sensor includes a gyroscope or a three-dimensional accelerometer.

In an exemplary embodiment, the controller is configured to process the images by performing an optical aberration removal step on the raw images to produce processed images and by performing a cropping step on the processed images to produce the displayed images. The cropping step includes cropping a first portion of the processed images in response to the first signal and cropping a second portion of the processed images in response to the second signal. The second portion is distinct from the first portion. The housing may be pivotable about a first axis and a second axis, and the controller may be configured to, in response to the housing being pivoted about the first axis, modify cropping of the processed images in a horizontal direction and, in response to the housing being pivoted about the second axis, modify cropping of the processed images in a vertical direction. The housing may also be pivotable about a third axis, and the controller may be configured to, in response to the housing being pivoted about the third axis, modify cropping of the processed images in a rotational direction. The housing may be coupled to the interior portion of the vehicle via a ball-and-socket interface, with the first axis being a vertical axis passing through the ball-and-socket interface, the second axis being a lateral axis passing through the ball-and-socket interface, and the third axis being a longitudinal axis passing through the ball-and-socket interface.

An automotive vehicle according to the present disclosure includes a body having an interior cabin, a camera coupled to the body, and a housing coupled to the cabin. The camera is configured to capture raw images. The housing is movable among a plurality of positions. A display screen is coupled to the housing. A position sensor is coupled to the housing and configured to produce a signal indicative of movement of the housing among the plurality of positions. The vehicle additionally includes a controller in communication with the camera, the sensor, and the display screen. The controller is configured to process the raw images, output first display images to the display screen, and, in response to the signal indicative of movement of the housing, output second display images to the display screen. The second display images have a different field of view from the first display images.

In an exemplary embodiment, the position sensor includes a gyroscope.

In an exemplary embodiment, the position sensor includes a three-dimensional accelerometer.

In an exemplary embodiment, the controller is configured to process the raw images by performing an optical aberration removal step on the raw images to produce processed images and by performing a cropping step on the processed images to produce the first and second display images. The cropping step includes cropping a first portion of the processed images to produce the first display images and cropping a second portion of the processed images to produce the second display images. The second portion is distinct from the first portion. In such an embodiment, the housing may be pivotable about a first axis and a second axis, and the controller may be configured to, in response to the housing being pivoted about the first axis, modify cropping of the processed images in a horizontal direction and, in response to the housing being pivoted about the second axis, modify cropping of the processed images in a vertical direction. The housing may additionally be pivotable about a third axis, and the controller may be configured to, in response to the housing being pivoted about the third axis, modify cropping of the processed images in a rotational direction. In such an embodiment, the housing may be coupled to the interior cabin of the vehicle via a ball-and-socket interface, the first axis may be a vertical axis passing through the ball-and-socket interface, the second axis may be a lateral axis passing through the ball-and-socket interface, and the third axis may be a longitudinal axis passing through the ball-and-socket interface.

In an exemplary embodiment, the body has an exterior, with the camera being disposed on the exterior.

A method of controlling a display system according to the present disclosure includes providing a camera configured to capture raw images, a display housing movably coupled to a surface, a display screen coupled to the housing, a position sensor coupled to the housing and configured to produce a signal indicative of movement of the housing, and a controller in communication with the camera, the display screen, and the position sensor. The method also includes outputting, via the controller, a first display image on the display screen. The first display image has a first field of view. The method additionally includes receiving, via the controller, the signal indicative of movement of the housing. The method further includes, in response to the signal indicative of movement of the housing, outputting, via the controller, a second display image on the display screen. The second display image has a distinct field of view from the first display image.

In an exemplary embodiment, the method additionally includes providing an automotive vehicle having a body with an interior cabin, with the surface being disposed in the interior cabin.

In an exemplary embodiment, outputting a first display image includes cropping, via the controller, a first portion of the raw images, and outputting a second display image includes cropping, via the controller, a second portion of the processed images. The second portion is distinct from the first portion. The housing may be pivotable about a first axis and a second axis, and the controller may be configured to, in response to the housing being pivoted about the first axis, modify cropping of the processed images in a horizontal direction and, in response to the housing being pivoted about the second axis, modify cropping of the processed images in a vertical direction. The housing may additionally be pivotable about a third axis, and the controller may be configured to, in response to the housing being pivoted about the third axis, modify cropping of the processed images in a rotational direction.

Embodiments according to the present disclosure provide a number of advantages. For example, the present disclosure provides an interface for adjusting an image on a display in a manner which is intuitive and familiar to operators, thereby increasing customer satisfaction. The above and other advantages and features of the present disclosure will be apparent from the following detailed description of the preferred embodiments when taken in connection with the accompanying drawings.

### BRIEF DESCRIPTION OF THE DRAWINGS

FIG. 1 is an illustrative view of an automotive vehicle according to an embodiment of the present disclosure;

FIG. 2 is an illustrative view of a display assembly according an embodiment of the present disclosure;

FIGS. 3A-3C are representations of processing images captured by a camera according to the present disclosure; and

FIG. 4 is a flowchart representation of a method of controlling a display according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desirable for particular applications or implementations.

Referring now to the drawings, FIG. 1 illustrates a vehicle 10 including a surround view vision-based imaging system 12 in accordance with an embodiment of the present disclosure. The vehicle is traveling along a road and the vision-based imaging system 12 captures images of the road. The vision-based imaging system 12 captures images surrounding the vehicle based on the location of one or more vision-based camera devices. In the embodiments described herein, the vision-based imaging system will be described as capturing images rearward of the vehicle; however, it should also be understood that in some embodiments contemplated within the scope of the present disclosure, the vision-based imaging system 12 may capture images forward of the vehicle and/or to the sides of the vehicle.

The vision-based imaging system 12 can include any combination of a front-view camera device 14 for capturing a field of view (FOV) forward of the vehicle 10, a rear-view camera device 16 for capturing a FOV rearward of the vehicle 10, a left-side view camera device 18 for capturing a FOV to a left side of the vehicle 10, and a right-side view camera for capturing a FOV on a right side of the vehicle 10. The cameras 14, 16, and 18 can be any camera suitable for the embodiments described herein, many of which are known in the automotive art, that are capable of receiving light, or other radiation, and converting the light energy to electrical signals in a pixel format using, for example, one of charged coupled device (CCD) sensors or complimentary metal-oxide-semiconductor (CMOS) sensors. The cameras 14, 16, and 18 generate frames of image data at a certain data frame rate that can be stored for subsequent processing. The cameras 14, 16, and 18 can be mounted within or on any suitable structure that is part of the vehicle, such as bumpers, spoilers, trunk lids, facie, grill, side-view mirrors, door panels, etc., as would be well understood and appreciated by those skilled in the art. Image data from the cameras 14, 16, and 18 is sent to a non-transitory processing device 22 (e.g., processor) that processes the image data to generate images that can be displayed on a rearview mirror display device 24.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any instruction sets including calibrations and look-up tables. The control module has a set of control routines executed to provide the desired functions. Routines are executed, such as by a central processing unit, and are operable to monitor inputs from sensing devices and other networked control modules, and execute control and diagnostic routines to control operation of actuators. Routines may be executed at regular intervals, for example each 3.125, 6.25, 12.5, 25 and 100 milliseconds during ongoing engine and vehicle operation. Alternatively, routines may be executed in response to occurrence of an event.

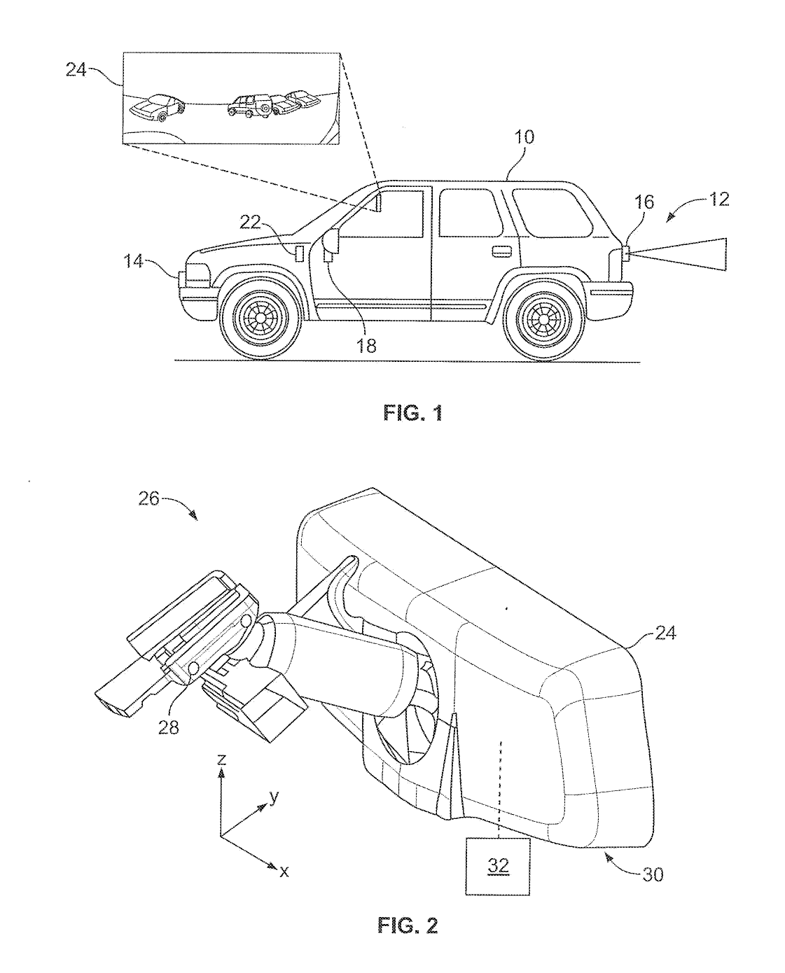

Referring now to FIG. 2, a rearview display assembly 26 is illustrated. The rearview display assembly 26 includes a mount 28 which is coupled to an interior portion of the vehicle 10, e.g. to a bracket secured to an interior surface of a vehicle windshield. The rearview display device 24 additionally includes a display housing 30. The rearview mirror display device 24 is disposed in the housing 30. In an exemplary embodiment, the rearview mirror display device 24 is a dual-mode display capable of selectively functioning as a conventional mirror in a first mode and displaying images from the cameras 14, 16, and 18 in a second mode. The display housing 30 is pivotably coupled to the mount 28, e.g. by a ball-and-socket joint. In an exemplary embodiment, the display housing 30 may be pivoted relative to the mount 28 about a vertical axis z, e.g. pivoting the display housing 30 from side-to-side, about a lateral axis x, e.g. pivoting the display housing 30 up or down, and about a longitudinal axis y, e.g. tilting the display housing 30.

A position sensor 32 is operably coupled to the display housing 30. The position sensor 32 is configured to detect a position of the display housing 30 relative to the mount 28, to detect motion of the display housing 30 relative to the mount 28, or both. In an exemplary embodiment, the position sensor 32 includes a gyroscope or a three-dimensional accelerometer. The position sensor 32 is in communication with the processor 22.

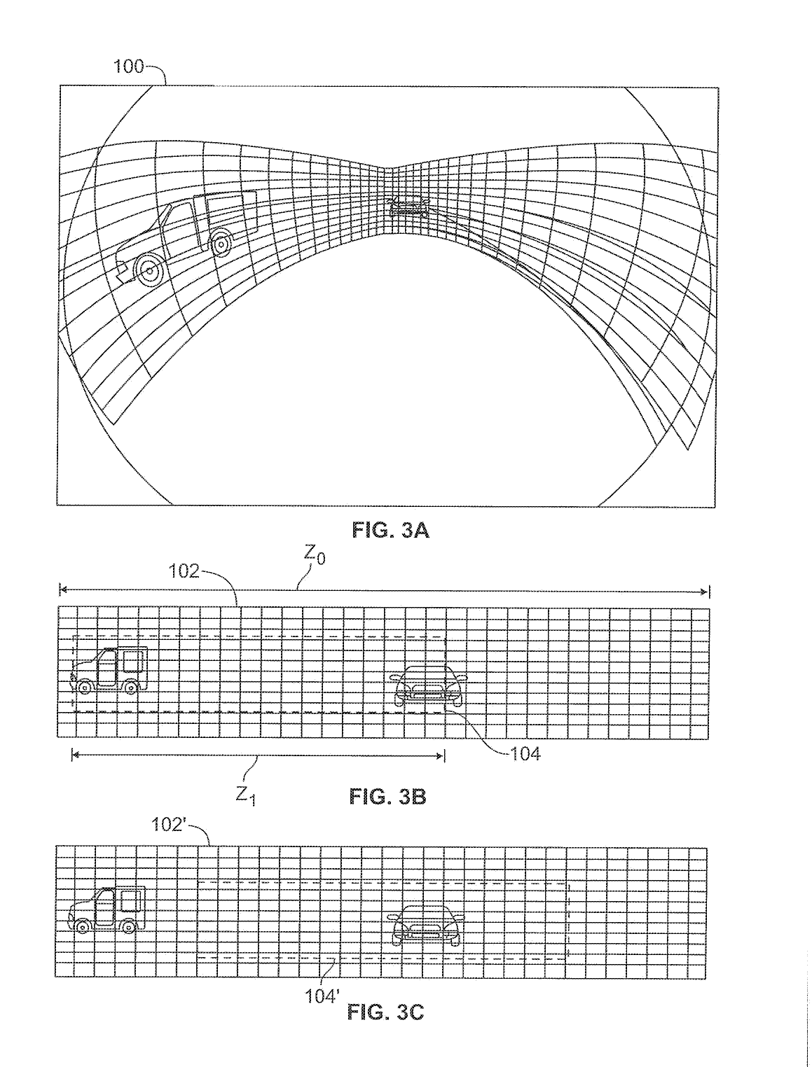

FIGS. 3A, 3B, and 3C illustrate an image captured by the rear-view camera device 16 of FIG. 1 representing a field of view (FOV) rearward of the vehicle 10, in accordance with the present disclosure. The rear-view camera device 16 can be a fish-eye camera device known in the art. In a non-limiting exemplary embodiment, the rear-view camera device 16 is configured to capture a 180° FOV rearward of the vehicle with a downward pitch. Image data from the camera device 16 can be processed by the processor 22 of FIG. 1 to generate an image that can be displayed on any suitable vehicle display units including the rearview mirror display device 24. While the embodiments described herein refer to the rear-view camera device 16 configured to capture the FOV rearward of the vehicle, it will be understood that the embodiments herein can be similarly applied to camera devices capturing images representing a FOV forward of the vehicle or to the sides of the vehicle.

Referring to FIG. 3A, a raw image 100 is captured by the camera device illustrating the FOV rearward of the vehicle. The raw image includes optical aberrations, such as spherical aberrations. In one embodiment, spherical aberrations resulting in the distorted center region occur when the raw image is captured by a fish-eye camera device.

Referring to FIG. 3B, the processor 22 applies digital or image processing to the raw image 100 of FIG. 2-1 to generate a processed image 102 in which the optical aberrations are removed, e.g. by stretching the raw image 100 to compensate for spherical aberrations. The digital or image processing may be performed according to any known processing techniques or algorithms as appropriate. The processor additionally crops the processed image 102 to obtain a display image 104 for display on the rearview mirror display device 24. The display image 104 has a display field of view Z₁ which is less than an overall field of view Z₀ of the processed image 102.

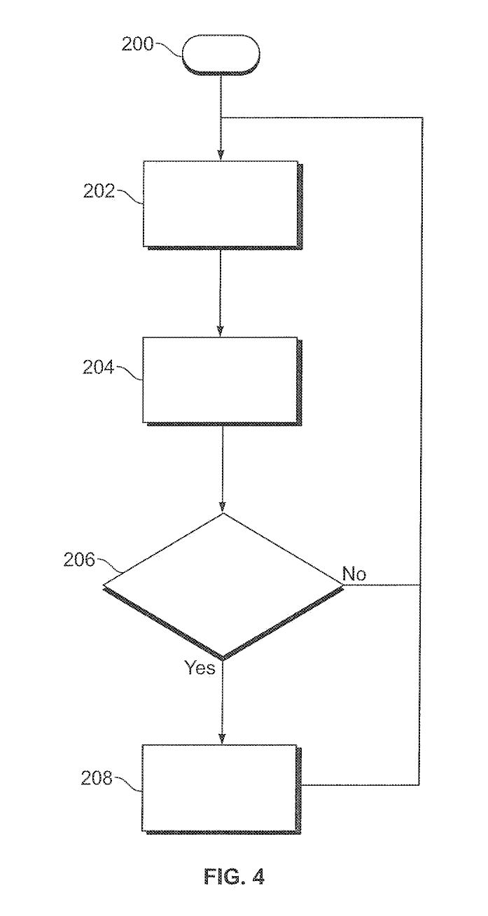

Various operators of the vehicle 10 may desire to view different portions of the region proximate the vehicle 10. The processor 22 is therefore configured to modify the cropping of the processed image 102 in response to operator movement of the display housing 30, as will be discussed in further detail below with respect to FIG. 4. In the exemplary embodiment illustrated in FIGS. 3B and 3C, in response to an operator moving the display housing 30 from a first position to a second position, the processor 22 modifies the cropped region from the display image 104 to a shifted display image 104′.

Referring now to FIG. 4, a method of controlling a display according to an embodiment of the present disclosure is illustrated in flowchart form. The algorithm begins at block 200.

Images from a camera are received, as illustrated at block 202. In various embodiments, the camera may be a front-view camera such as the front-view camera device 14, a rear-view camera such as the rear-view camera device 16, or a side-view camera such as the left-side view camera device 18.

The images are processed and cropped, as illustrated at block 204. As discussed above, the processing may be performed using any appropriate methods for removing optical aberrations.

A determination is then made of whether movement of the display housing is detected, as illustrated at operation 206. The determination may be performed by a controller, e.g. arranged similarly as the processor 22 illustrated in FIG. 1, based on signals from a position sensor, e.g. arranged similarly as the position sensor 32 illustrated in FIG. 2. As discussed above with respect to the embodiment illustrated in FIG. 2, the position sensor may include, for example, a gyroscope, a three-dimensional accelerometer, or other appropriate angular position sensor. In the embodiment illustrated in FIG. 2, the detected motion may include pivoting about a lateral axis, a longitudinal axis, a vertical axis, or a combination thereof.

If the determination of operation 206 is negative, i.e. no movement of the housing is detected, then control returns to block 202. The display therefore continues to present images from the camera in a consistent manner unless and until movement of the housing is detected.

If the determination of operation 206 is positive, then the cropped region is modified based on the detected movement. In the exemplary embodiment illustrated in FIG. 2, the modification of the cropped region may be consistent with image transformation in a conventional mirror. In response to pivoting motion about the lateral axis, the cropped region may be panned in an up or down direction. In response to pivoting motion about the vertical axis, the cropped region may be panned in a sideways direction. In response to pivoting motion about the longitudinal axis, the cropped region may be rotated. In such an embodiment, the resulting image adjustment is consistent with behavior of a conventional mirror. Control then returns to block 202.

In an alternative embodiment, a vehicle may be provided with a movable camera assembly. In such an embodiment, camera orientation may be modified in response to movement of the display housing in a generally similar fashion as discussed above.

While the above has been describe largely in conjunction with rear-view display assemblies for an automotive vehicle, other embodiments contemplated within the scope of the present disclosure may apply to displays for other types of vehicles or for non-vehicular use.

The present disclosure thereby provides an interface for adjusting an image on a display in a manner which is intuitive and familiar to operators, thereby increasing customer satisfaction. Moreover, these advantages are provided without necessitating additional interface elements such as buttons or knobs.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A display system comprising:
a camera configured to capture raw images of a region proximate a vehicle;
a housing movably coupled to an interior portion of the vehicle, the housing being movable between distinct first and second positions;
a position sensor coupled to the housing and configured to produce a first signal in response to the housing being in the first position and a second signal in response to the housing being in the second position;
a controller in communication with the camera and the sensor, the controller being configured to process the raw images, output display images with a first field of view in response to the first signal, and output display images with a second field of view in response to the second signal; and
a display screen disposed in the housing, the display screen being in communication with the controller and configured to display the display images.

2. The rear view system of claim 1, wherein the position sensor includes a gyroscope.

3. The display system of claim 1, wherein the position sensor includes a three-dimensional accelerometer.

4. The display system of claim 1, wherein the controller is configured to process the raw images by performing an optical aberration removal step on the raw images to produce processed images and by performing a cropping step on the processed images to produce the displayed images, the cropping step including cropping a first portion of the processed images in response to the first signal and cropping a second portion of the processed images in response to the second signal, the second portion being distinct from the first portion.

5. The display system of claim 4, wherein the housing is pivotable about a first axis and a second axis, and wherein the controller is configured to, in response to the housing being pivoted about the first axis, modify cropping of the processed images in a horizontal direction and, in response to the housing being pivoted about the second axis, modify cropping of the processed images in a vertical direction.

6. The display system of claim 5, wherein the housing is additionally pivotable about a third axis, and wherein the controller is configured to, in response to the housing being pivoted about the third axis, modify cropping of the processed images in a rotational direction.

7. The display system of claim 6, wherein the housing is coupled to the interior portion of the vehicle via a ball-and-socket interface, the first axis is a vertical axis passing through the ball-and-socket interface, the second axis is a lateral axis passing through the ball-and-socket interface, and the third axis is a longitudinal axis passing through the ball-and-socket interface.

8. An automotive vehicle comprising:
a body having an interior cabin;
a camera coupled to the body and configured to capture raw images;
a housing movably coupled to the cabin, the housing being movable among a plurality of positions;
a display screen coupled to the housing;
a position sensor coupled to the housing and configured to produce a signal indicative of movement of the housing among the plurality of positions;
a controller in communication with the camera, the sensor, and the display screen, the controller being configured to process the raw images, output first display images to the display screen, and, in response to the signal indicative of movement of the housing, output second display images to the display screen, the second display images having a different field of view from the first display images.

9. The automotive vehicle of claim 7, wherein the position sensor includes a gyroscope.

10. The automotive vehicle of claim 7, wherein the position sensor includes a three-dimensional accelerometer.

11. The automotive vehicle of claim 7, wherein the controller is configured to process the raw images by performing an optical aberration removal step on the raw images to produce processed images and by performing a cropping step on the processed images to produce the first and second display images, the cropping step including cropping a first portion of the processed images to produce the first display images and cropping a second portion of the processed images to produce the second display images, the second portion being distinct from the first portion.

12. The automotive vehicle of claim 11, wherein the housing is pivotable about a first axis and a second axis, and wherein the controller is configured to, in response to the housing being pivoted about the first axis, modify cropping of the processed images in a horizontal direction and, in response to the housing being pivoted about the second axis, modify cropping of the processed images in a vertical direction.

13. The automotive vehicle of claim 12, wherein the housing is additionally pivotable about a third axis, and wherein the controller is configured to, in response to the housing being pivoted about the third axis, modify cropping of the processed images in a rotational direction.

14. The automotive vehicle of claim 13, wherein the housing is coupled to the interior cabin of the vehicle via a ball-and-socket interface, the first axis is a vertical axis passing through the ball-and-socket interface, the second axis is a lateral axis passing through the ball-and-socket interface, and the third axis is a longitudinal axis passing through the ball-and-socket interface.

15. The automotive vehicle of claim 7, wherein the body has an exterior, the camera being disposed on the exterior.

16. A method of controlling a display system comprising:
providing a camera configured to capture raw images, a display housing movably coupled to a surface, a display screen coupled to the housing, a position sensor coupled to the housing and configured to produce a signal indicative of movement of the housing, and a controller in communication with the camera, the display screen, and the position sensor;
outputting, via the controller, a first display image on the display screen, the first display image having a first field of view;
receiving, via the controller, the signal indicative of movement of the housing; and
in response to the signal indicative of movement of the housing, outputting, via the controller, a second display image on the display screen, the second display image having a distinct field of view from the first display image.

17. The method of claim 16, further comprising providing an automotive vehicle having a body with an interior cabin, the surface being disposed in the interior cabin.

18. The method of claim 16, wherein outputting a first display image includes cropping, via the controller, a first portion of the raw images, and wherein outputting a second display image includes cropping, via the controller, a second portion of the processed images, the second portion being distinct from the first portion.

19. The method of claim 18, wherein the housing is pivotable about a first axis and a second axis, and wherein the controller is configured to, in response to the housing being pivoted about the first axis, modify cropping of the processed images in a horizontal direction and, in response to the housing being pivoted about the second axis, modify cropping of the processed images in a vertical direction.

20. The method of claim 19, wherein the housing is additionally pivotable about a third axis, and wherein the controller is configured to, in response to the housing being pivoted about the third axis, modify cropping of the processed images in a rotational direction.
